(19) United States
(12) Patent Application Publication
(10) Pub. No.: US 2005/0201638 A1
(43) Pub. Date: Sep. 15, 2005

(54) Method and system for measuring an object in digital image

(76) Inventor: Hanbyn Cha, Daejeon (KR)

Correspondence Address: PARK & SUTTON LLP, 3255 WILSHIRE BLVD, SUITE 1110, LOS ANGELES, CA, 90010, US

(21) Appl. No.: 10/799,399

(22) Filed: Mar. 12, 2004

(51) Int. Cl. G06K 9/00; G06K 9/36

(52) U.S. Cl. 382/286; 382/294

(57) ABSTRACT

A method and a system of measuring an object in a two-dimensional digital image are provided. The object is moved to cover the portion that is outside a viewing window, and a first image of the object, which is captured before the object is moved, and a second image of the object, which is captured after the object is moved are used in measuring. Displacement of the image is detected by comparing the position of one reference point of the object in the first image and the position of the same reference point of the object in the second image. And the geometrical data of the object is calculated with the displacement data. The second image is overlapped with the first image by finding the position at which sum of the luminosity value of the first image and the reversed luminosity value of the second image is minimized.

### BACKGROUND OF THE INVENTION

The present invention relates to method and system of measuring an object in a digital image. More particularly, this invention relates to method and system of measuring an object in a digital image when the image is bigger than a viewing window of an optical instrument such as a microscope.

There have been many image analysis programs or image measurement programs that measure objects in a digital image obtained by a microscope or a digital camera with the pixel values displayed in a computer monitor window that is connected to the microscope or digital camera. If an object is big and thus cannot be displayed as a whole in the monitor window, direct measurement from the image displayed in the monitor at a given moment is not possible.

In order to measure such oversize objects, a measuring microscope with a measuring stage and a profile projector have been used. FIG. 1 shows an example of a microscope 10 by prior art. A measuring stage 12 moves an object in X/Y/Z axes, and provides the X/Y/Z coordinates of an object before and after the movement. A measuring program by prior art used the data provided by a measuring stage to measure the size of an object in a digital image. A measuring stage needs to provide precise movement of an object to be measured and accurately measure movement in the XY plane or the XYZ space. This requires expensive mechanical parts, interfaces and other accommodations between the measuring stage and the measuring program.

### SUMMARY OF THE INVENTION

The present invention contrives to solve the disadvantages of the prior art.

An objective of the invention is to provide a measuring method and system for measuring oversize objects in a digital image without a measuring stage.

Another objective of the invention is to provide a digital image measuring method and system that has a manual, semi-automatic and automatic modes to maximize efficiency and versatility of the system.

Still another objective of the invention is to provide a digital image measuring method and system that can recognize and determine the moving distance and geometrical data of multiple objects in a digital image.

To achieve the above objectives, the present invention provides a method of measuring an object in a two-dimensional digital image. The object is moved to cover a portion of the object that is not viewed in a viewing window. A first image of the object, which is captured before the object is moved, and a second image of the object, which is captured after the object is moved, are used in measuring. The method includes the steps of detecting two-dimensional displacement of the image by comparing the position of one reference point of the object in the first image and the position of the same reference point of the object in the second image, and calculating geometrical data of the object.

The step of detecting two-dimensional displacement includes moving the second image so that the second image overlaps the first image.

In the step of moving the second image, overlapping is determined by minimizing sum of the luminosity value of a specific point or area of the first image and the luminosity value of the same point or area of the second image. The luminosity of a part of the second image, which includes the point or area, is set to be the negative value of the luminosity of the originally captured second image.

The step of detecting two-dimensional displacement may be repeated one or more times in order to cover a large object.

In the step of detecting two-dimensional displacement, the coordinates of one or more points of the object in the first image are memorized. When the object is moved, the displacement of the object is automatically calculated. The automatic calculation may be performed within a partial range of the first image determined by a user. This is advantageous when there are many objects of the same pattern. The overlapping may be performed manually also.

In case that the geometrical data is one-dimensional, the two-dimensional coordinates of a measuring point of the first image relative to the reference point, and the two-dimensional coordinates of a measuring point of the second image relative to the reference point are used in the step of calculating the geometrical data of the object.

In case that the geometrical data is two-dimensional, the two-dimensional coordinates of one or more measuring points of the first image relative to the reference point, and the two-dimensional coordinates of one or more measuring points of the second image relative to the reference point are used in the step of calculating the geometrical data of the object.

The invention also provides a system of measuring an object in a two-dimensional digital image. The system includes a detection module detecting two-dimensional displacement of the image by comparing the position of one reference point of the object in the first image and the position of the same reference point of the object in the second image, and a calculation module calculating geometrical data of the object.

The detection module moves the second image so that the second image overlaps the first image. In the detection module, overlapping is determined by minimizing sum of the luminosity value of a specific point or area of the first image and the luminosity value of the same point or area of the second image. The luminosity of a part of the second image, which includes the point or area, is set to be the negative value of the luminosity of the originally captured second image.

The detection module repeats detecting two-dimensional displacement one or more times as needed.

The detection module memorizes the coordinates of one or more points of the object in the first image. When the object is moved, the detection module automatically calculates the displacement of the object. This calculation may be performed within a partial range of the first image determined by a user.

The calculation module uses the two-dimensional coordinates of one or more measuring points of the first image relative to the reference point, and the two-dimensional coordinates of one or more measuring points of the second image relative to the reference point in calculating the one-dimensional or two-dimensional geometrical data of the object.

The advantages of the present invention are: (1) a digital microscope that does not need a measuring stage and measures objects only from the data included in digital images themselves is provided; and (2) a digital image measuring software that has various user-friendly features and powerful calculation options is provided.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic elevation view showing a microscope by prior art;

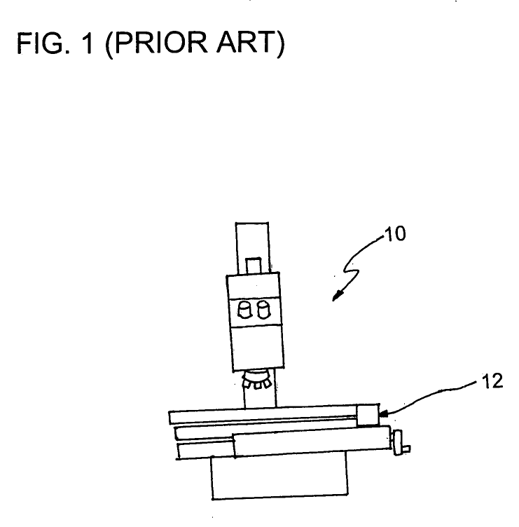

FIG. 2 is a flow diagram showing a digital image measuring method according to the present invention;

FIG. 3 is a block diagram showing a digital image measuring system according to the present invention;

FIG. 4 is a screen capture showing a preview window;

FIG. 5 is a screen capture showing a reference point on a object in a first image;

FIG. 6 is a screen capture showing a second image of the moved object;

FIG. 7 is a screen capture showing the first image and the second image simultaneously;

FIG. 8 is a screen capture showing the second image is overlapped with the first image;

FIG. 9 is a screen capture showing coordinates of the reference point is compensated;

FIG. 10 is a screen capture showing coordinates of a point on the object is compensated; and

FIG. 11 is a screen capture showing a menu for automatic calculation parameters.

### DETAILED DESCRIPTION OF THE INVENTION

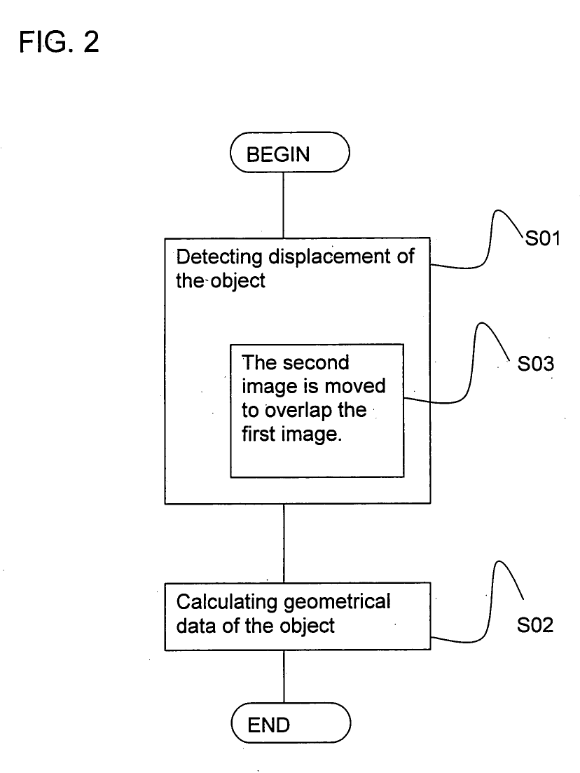

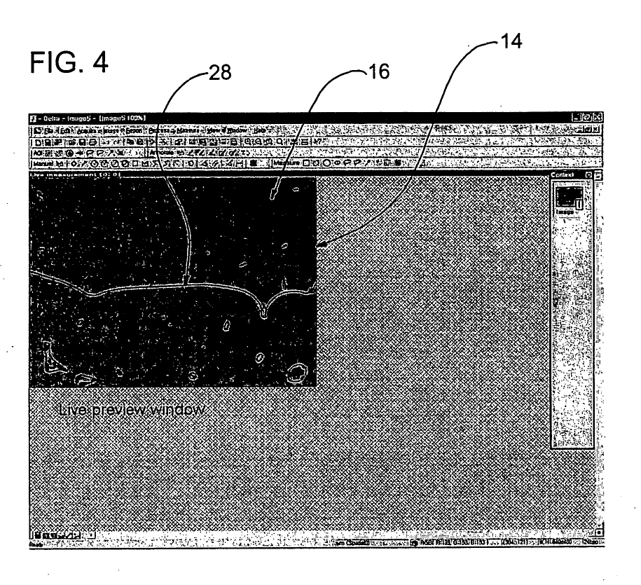

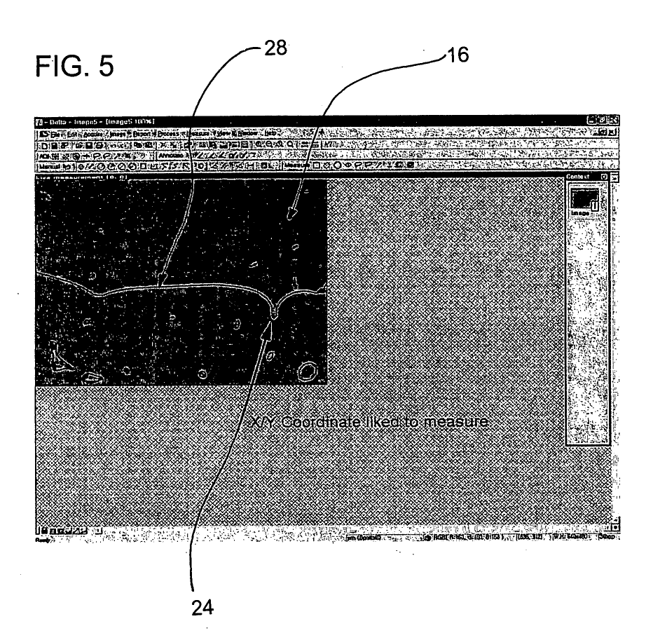

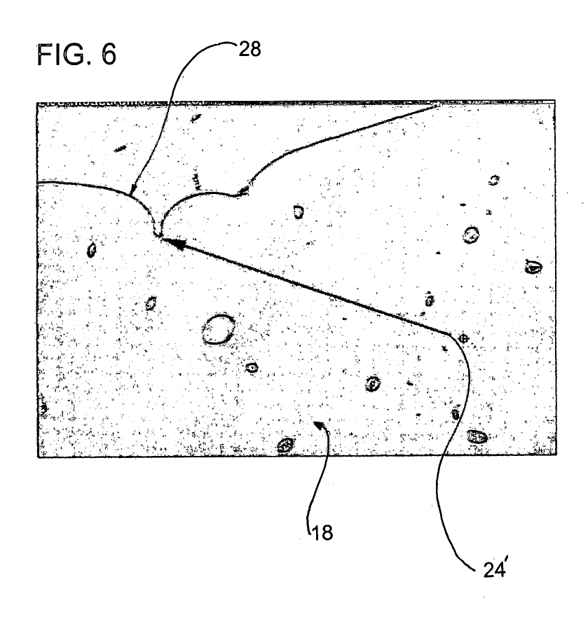

FIG. 2 shows a flow diagram for a digital image measuring method according to the present invention. The object is moved to cover a portion of the object that is not viewed in a viewing window 14 (refer to FIG. 4). A first image 16 of the object (refer to FIG. 5), which is captured before the object is moved, and a second image 18 of the object (refer to FIG. 6), which is captured after the object is moved are used in measuring. The method includes step S01 of detecting two-dimensional displacement of the image by comparing the position of one reference point of the object in the first image and the position of the same reference point of the object in the second image, and step S02 of calculating geometrical data of the object.

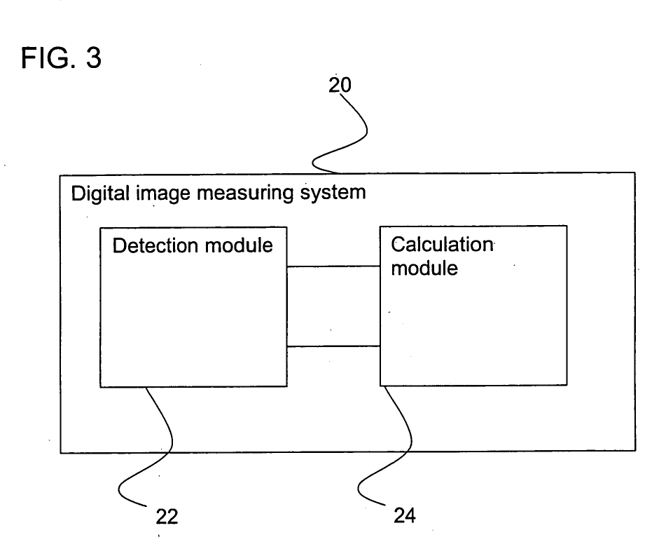

FIG. 3 shows a digital image measuring system 20 according to the present invention. The system 20 includes a detection module 22 that detects two-dimensional displacement of the image by comparing the position of one reference point 24 (refer to FIG. 5) of the object in the first image 16 and the position of the same reference point 24 of the object in the second image 18, and a calculation module 26 that calculates geometrical data of the object.

FIGS. 4-10 are screen captures that illustrate operations of the system 20. FIG. 4 shows the viewing window 14 of a digital optical instrument, for example, a microscope. FIG. 5 shows a reference point 24 on an object 28 in the first image 16.

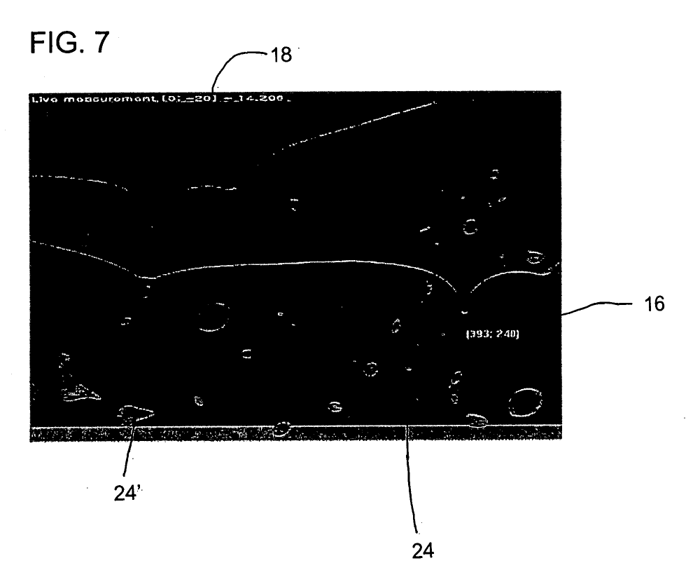

The object 28 is moved in order to cover portions of the object 28 that are not seen in the viewing window 14. This movement is done by a stage attached to a microscope. In this case the stage has only the role of moving the object 28 and does not provide displacement data like a measuring stage. The first image 16 is captured before the object 28 is moved, and the second image 18 is captured after the object 28 is moved. FIG. 6 shows the second image 18 of the moved object 28 with a reference point 24′ that corresponds the reference point 24 of the first image 16. FIG. 7 shows the first image 16 and the second image 18 simultaneously.

Step S01 of detecting two-dimensional displacement S01 includes a step S03 of moving the second image 18 or the first image 16 so that the second image 18 overlaps the first image 16. This movement of the second image 18 is performed by the detection module 22 of the digital image measuring system 20.

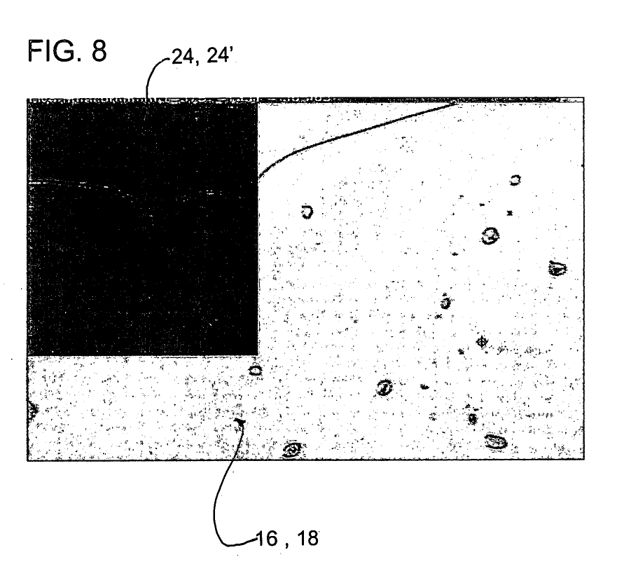

FIG. 8 shows that the second image 18 is overlapped with the first image 16 with the reference point 24, 24′ coincided with each other.

In step S03 of moving the second image, overlapping is determined by minimizing sum of the luminosity value of the reference point 24 or an area of the first image 16 and the luminosity value of the reference point 24′ or an area of the second image 18. The luminosity of a part of the second image 18, which includes the reference point 24′ or area, is set to be the negative value of the luminosity of the originally captured second image 18.

Step S01 of detecting two-dimensional displacement may be repeated one or more times by the detection module 22 in order to cover a large object.

In a first embodiment, in step S01 of detecting two-dimensional displacement, the coordinates of one or more points of the object 28 in the first image 16 are memorized by the detection module 22. When the object 28 is moved, the displacement of the object 28 is automatically calculated by the detection module 22.

In a second embodiment, the automatic calculation may be performed within a partial range of the first image 16 determined by a user. The first image 16 or the second image 18 is moved to the other image manually. Then automatic detection is perform with the partial range. This is advantageous when there are many objects of the same pattern. In a third embodiment, the overlapping is performed by manually moving the object 28. An indicator shows the sum of luminosity values that is explained above. When the value shown by the indicator is minimized, the first image 16 and the second image 18 are overlapped.

In case that the geometrical data is one-dimensional, such as length or width of the object 28, the two-dimensional coordinates of a measuring point of the first image 16 relative to the reference point 24, and the two-dimensional coordinates of a measuring point of the second image 18 relative to the reference point 24′ are used in step S02 of calculating the geometrical data of the object 28 by the calculation 26 of the digital image measuring system 20.

In case that the geometrical data is two-dimensional, such as the area of the object 28, the two-dimensional coordinates of one or more measuring points of the first image 16 relative to the reference point 24, and the two-dimensional coordinates of one or more measuring points of the second image 18 relative to the reference point 24′ are used in step S02 of calculating the geometrical data of the object 28.

The geometrical data provided by the digital image measuring system 20 includes the length, area, radius, diameter, angle and distance, etc. of the object 28.

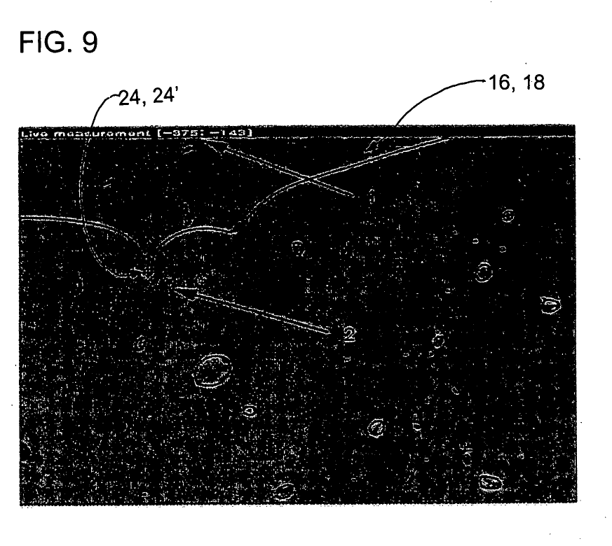

FIG. 9 shows that coordinates of the reference point 24, 24′ is compensated or calculated according to the result of step S01. Arrow 1 means X, Y coordinate pixel values of the moved window. Arrow 2 shows that X, Y coordinates of the reference points are compensated with the value indicated by arrow 1.

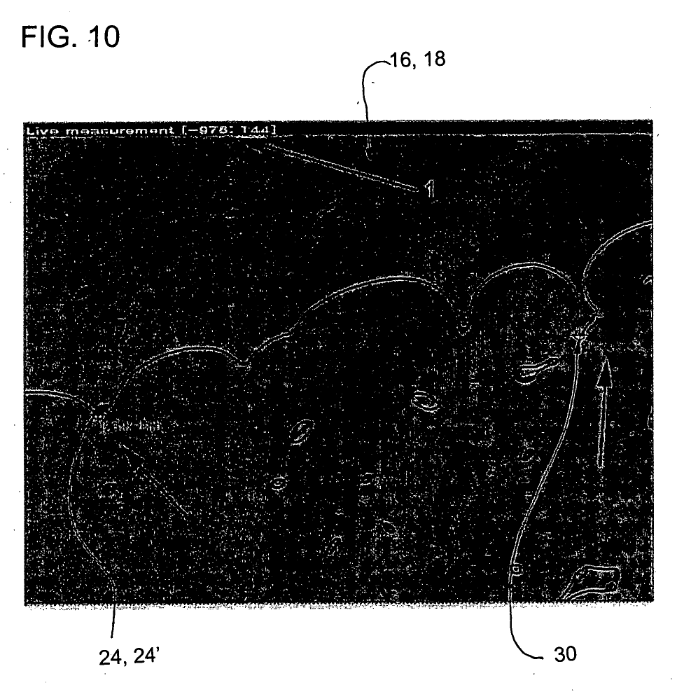

FIG. 10 shows that the coordinates of a point 30 on the object 28 is compensated or calculated in a way similar to that in FIG. 9.

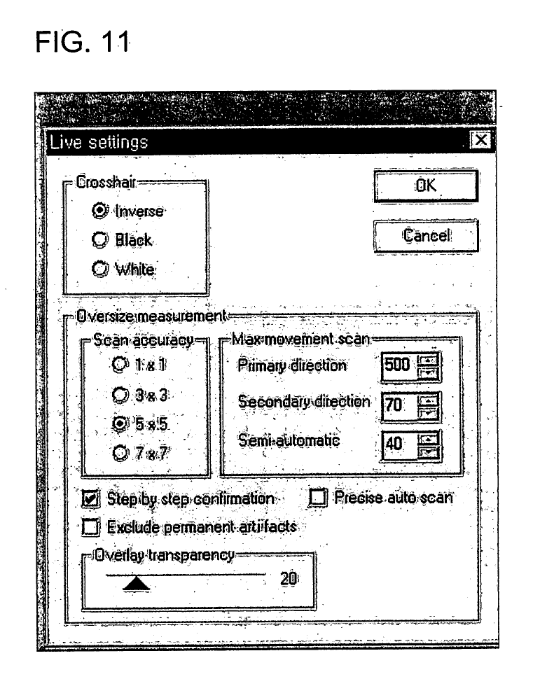

FIG. 11 shows a menu for automatic calculation parameters that are used in the method of the present invention. Max movement scan indicates the range in which the digital image measuring system 20 detects displacements automatically. Primary direction means X-axis, and secondary direction means Y-axis. FIG. 11 shows the range as 500 pixels in primary direction and 70 pixels in the secondary direction. The numbers can be adjusted by the user.

While the invention has been shown and described with reference to different embodiments thereof, it will be appreciated by those skilled in the art that variations in form, detail, compositions and operation may be made without departing from the spirit and scope of the invention as defined by the accompanying claims.

1. A method of measuring an object in a two-dimensional digital image, wherein the object is moved, and a first image of the object, which is captured before the object is moved, and a second image of the object, which is captured after the object is moved are used in measuring, the method comprising:
a) detecting two-dimensional displacement of the image by comparing the position of one reference point of the object in the first image and the position of the same reference point of the object in the second image; and
b) calculating geometrical data of the object.

2. The method of claim 1, wherein the step of detecting two-dimensional displacement comprises moving the second image so that the second image overlaps the first image.

3. The method of claim 2, wherein in the step of moving the second image, overlapping is determined by minimizing sum of the luminosity value of a specific point or area of the first image and the luminosity value of the same point or area of the second image, wherein the luminosity of a part of the second image, which includes the point or area, is set to be the negative value of the luminosity of the originally captured second image.

4. The method of claim 2, wherein the step of detecting two-dimensional displacement is repeated one or more times.

5. The method of claim 2, wherein in the step of detecting two-dimensional displacement, the coordinates of one or more points of the object in the first image are memorized, wherein when the object is moved, the displacement of the object is automatically calculated.

6. The method of claim 2, wherein in the step of detecting two-dimensional displacement, the coordinates of one or more points of the object in the first image are memorized, wherein when the object is moved, the displacement of the object is automatically calculated within a partial range of the first image determined by a user.

7. The method of claim 2, wherein the geometrical data is one-dimensional, wherein the two-dimensional coordinates of a measuring point of the first image relative to the reference point, and the two-dimensional coordinates of a measuring point of the second image relative to the reference point are used in the step of calculating the geometrical data of the object.

8. The method of claim 2, wherein the geometrical data is two-dimensional, wherein the two-dimensional coordinates of one or more measuring points of the first image relative to the reference point, and the two-dimensional coordinates of one or more measuring points of the second image relative to the reference point are used in the step of calculating the geometrical data of the object.

9. A system of measuring an object in a two-dimensional digital image, wherein the object is moved, and a first image of the object, which is captured before the object is moved, and a second image of the object, which is captured after the object is moved are used in measuring, the system comprising:
a) a detection module detecting two-dimensional displacement of the image by comparing the position of one reference point of the object in the first image and the position of the same reference point of the object in the second image; and
b) a calculation module calculating geometrical data of the object.

10. The system of claim 9, wherein the detection module moves the second image so that the second image overlaps the first image.

11. The system of claim 10, wherein in the detection module, overlapping is determined by minimizing sum of the luminosity value of a specific point or area of the first image and the luminosity value of the same point or area of the second image, wherein the luminosity of a part of the second image, which includes the point or area, is set to be the negative value of the luminosity of the originally captured second image.

12. The system of claim 10, wherein the detection module repeats detecting two-dimensional displacement one or more times.

13. The system of claim 10, wherein the detection module memorizes the coordinates of one or more points of the object in the first image, wherein when the object is moved, the detection module automatically calculates the displacement of the object.

14. The system of claim 10, wherein the detection module memorizes the coordinates of one or more points of the object in the first image, wherein when the object is moved, the detection module automatically calculates the displacement of the object within a partial range of the first image determined by a user.

15. The system of claim 10, wherein the geometrical data is one-dimensional, wherein the two-dimensional coordinates of a measuring point of the first image relative to the reference point, and the two-dimensional coordinates of a measuring point of the second image relative to the reference point are used by the calculation module in calculating the geometrical data of the object.

16. The system of claim 10, wherein the geometrical data is two-dimensional, wherein the two-dimensional coordinates of one or more measuring points of the first image relative to the reference point, and the two-dimensional coordinates of one or more measuring points of the second image relative to the reference point are used by the calculation module in calculating the geometrical data of the object.
